(19) United States
(12) Patent Application Publication
(10) Pub. No.: US 2006/0132912 A1
(43) Pub. Date: Jun. 22, 2006

(54) Substrate materials for transparent injection-molded parts

(75) Inventors: Wilfried Haese, Odenthal (DE); Burkhard Reitze, Bergisch Gladbach (DE); Michael Roppel, Burscheid (DE); Michael Prein, Krefeld (DE); Alexander Meyer, Dusseldorf (DE)

Correspondence Address: BAYER MATERIAL SCIENCE LLC, 100 BAYER ROAD, PITTSBURGH, PA, 15205, US

(73) Assignee: Bayer Material Science AG

(21) Appl. No.: 11/312,162

(22) Filed: Dec. 20, 2005

(30) Foreign Application Priority Data
Dec. 22, 2004 (DE) 102004061754.6

(51) Int. Cl. G03B 21/60

(52) U.S. Cl. 359/457

(57) ABSTRACT

A substrate material, preferably polycarbonate, suitable for producing transparent injection-molded coated disks is disclosed. The material is characterized in that a substrate molded therefrom has an electrical field (measured within 5 minutes of its molding and at a distance of 100 mm from the surface) of −30 to 0 kV/m.

### FIELD OF THE INVENTION

The invention is directed to material suitable for making optical recording media and particularly to recording media characterized by the integral value of the electrical field.

### TECHNICAL BACKGROUND OF THE INVENTION

The present invention provides a polymeric material, preferably polycarbonate, as a substrate material for the production of transparent injection-molded parts, in particular for the production of injection-molded parts and moldings which are to be coated. Moldings may be e.g. transparent sheets, lenses, optical storage media or carriers for optical storage media or also articles from the automotive glazings sectors, such as e.g. diffusing screens. The present invention provides, in particular, optical storage media and carriers for optical storage media, such as e.g. writable optical data storage media which have a good coatability and wetting capacity and are suitable e.g. for application of dyestuffs from solution, in particular from non-polar media. The optical injection-molded parts from the polymeric materials according to the invention furthermore have a relatively low tendency towards soiling.

Transparent injection-molded parts are of importance above all in the glazings and storage media sector.

Optical data recording materials are increasingly being used as a variable recording and/or archiving media for large amounts of data. Examples of this type of optical data storage media are CD, super-audio-CD, CD-R, CD-RW, DVD, DVD-R, DVD+R, DVD-RW, DVD+RW and BD.

Transparent thermoplastics, such as, for example polycarbonate, polymethyl methacrylate and chemical modifications thereof, are typically employed for optical storage media. Polycarbonate as a substrate material is suitable, in particular, for optical disks which are writable once and readable several times and also for those which are writable several times, and for the production of moldings from the automotive glazing sector, such as e.g. diffusing screens. This thermoplastic has an excellent mechanical stability, has a low susceptibility to changes in dimensions and is distinguished by a high transparency and impact strength.

DE-A 2 119 799 disclosed the preparation of polycarbonates having a phenolic end groups, by the phase interface process (or interfacial process, respectively) and also the process in a homogeneous phase.

Polycarbonate prepared by the phase interface process may be used for the production of optical data storage media of the formats described above, such as e.g. for compact disks (CD) or digital versatile disks (DVD). These disks often have the property of building up a high electrical field during their production in the injection molding process. This high field strength on the substrate during production of the optical data storage media leads e.g. to attraction of dust from the environment or to sticking of the injection-molded articles, such as e.g. the disks, to one another, which reduces the quality of the finished injection-molded articles and makes the injection molding process difficult.

It is furthermore known that electrostatic charging, in particular of disks (for optical data carriers), leads to a lack of wettability, above all with non-polar media, such as e.g. a non-polar dyestuff or a dyestuff application from solvents, such as e.g. dibutyl ether, ethylcyclohexane, tetrafluoropropanol, cyclohexane, methylcyclohexane or octafluoropropanol. Thus, a high electrical field on the surface of the substrate during the application of dyestuffs on writable data storage media causes, for example, an irregular coating with dyestuff and therefore leads to defects in the information layer.

The degree of electrostatic charging of a substrate material may be quantified e.g. by measurement of the electrical field at a particular distance from its surface.

In the case of an optical data storage medium in which a writable substrate is applied to the surface in a spin coating process, a low absolute electrical field strength is necessary in order to enable uniform application of the writable layer and a trouble-free production process.

Because of the facts described above, a high electrostatic field moreover causes losses in yield in respect of the substrate material. This may lead to interruptions in the particular production step and is associated with high costs.

Several paths have been followed to solve this problem of high static charging. In general, antistatics are added to the substrate material as additives. Antistatic polycarbonate compositions are described e.g. in JP 62 207 358-A. In this specification, phosphoric acid derivatives, inter alia, are added to the polycarbonate as antistatics. EP 0922 728 describes various antistatics, such as polyalkylene glycol derivatives, ethoxylated sorbitan monolaurate, polysiloxane derivatives, phosphine oxides and distearylhydroxyamine, which are employed individually or as mixtures. The Japanese Application JP 62 207 358 describes esters of phosphorous acid as additives. U.S. Pat. No. 5,668,202 describes sulfonic acid derivatives. U.S. Pat. No. 6,262,218 and 6,022,943 describe the use of phenyl chloroformate in order to increase the end group content in melt polycarbonate. According to these, an end group level greater than 90% is said to have a positive effect on the electrostatic properties. In WO 00/50 488, 3,5-di-tert-butylphenol is employed as a chain terminator in the phase interface process. This chain terminator leads to a lower static charging of the corresponding substrate material compared with conventional chain terminators. JP 62 207 358-A describes polyethylene derivatives and polypropylene derivatives as additives for polycarbonate. EP-A 1 304 358 describes the use of short oligomers, such as e.g. bisphenol A bis-(4-tert-butylphenyl carbonate) in polycarbonate from the transesterification process.

However, the additives described may also have an adverse effect on the properties of the material, since they tend to migrate from the material. This is indeed a desirable effect for the antistatic properties, but may lead to formation of surface deposits or defective molding. The content of oligomers in the case of polycarbonate may moreover also lead to a poorer level of mechanical properties and to a lowering of the glass transition temperature. These additives may furthermore cause side reactions. Subsequent “end-capping” of polycarbonate which has been obtained from the transesterification process is expensive and the results achieved are lacking. The introduction of new end groups into the material is associated with high costs.

The object is therefore to provide a composition which is suitable for making substrate characterized by good electrical field on its surface that avoid the disadvantages described above.

Those substrate materials which comprise little or no additives are most advantageous. Thus e.g. the antistatics described in EP-A 922 728, such as polyoxyethylene sorbitan monolaurate, polyoxyethylene monolaurate and polyoxyethylene monostearate, are indeed active in respect of the antistatic properties in the amounts added, of 50-200 ppm, but may be a disadvantage for the overall performance of the injection-molded article, as described above.

These materials thus show initially good antistatic properties, which disappear, however, in the course of a continuous injection molding process. As described above, the additives may migrate from the material and in the case of a continuous injection molding process in this way lead to surface defects on the moldings and to malfunctions in the production process. The initial antistatic efficacy may also be lost and lead to high electrostatic fields on the moldings.

It is therefore advantageous to employ a substrate material which contains little or no antistatic additives.

The material may also contain additional additives, e.g. flameproofing agents, mold release agents, UV stabilizers and heat stabilizers. Nevertheless, the amount of additives employed is to be kept as low as possible for the reasons described above. Examples of such additives, that are suitable in the context of polycarbonates are mold release agents based on stearic acid and/or stearyl alcohol, particularly preferably pentaerythritol stearate, trimethylolpropane tristearate, pentaerythritol distearate, stearyl stearate and glycerol monostearate, as well as heat stabilizers based on phosphanes, phosphites and phosphoric acid.

### SUMMARY OF THE INVENTION

A substrate material, preferably polycarbonate, suitable for producing transparent injection-molded coated disks is disclosed. The material is characterized in that a substrate molded therefrom has an integral value of the electrical field (measured within 5 minutes of its molding and at a distance of 100 mm from the surface) of −30 to 0 kV/m.

### BRIEF DESCRIPTION OF THE FIGURES

FIG. 1 shows the electric field measurements of disks produced at various times after the start of the injection molding process meeting the inventive criteria.

FIG. 2 shows the electric field measurements of disks produced at various times after the start of the injection molding process failing to meet the inventive criteria.

### DETAILED DESCRIPTION OF THE INVENTION

The present invention provides a substrate material which may be used in particular for rewritable optical data carriers having a good coatability and wettability and low tendency towards soiling. The substrate material according to the invention leads to a low rate of rejects in the production process.

It has been found, surprisingly, that the electrostatic field (integral value of the electrical field) which arises on any injection-molded parts in the course of the injection molding process is not constant during the production process but follows a particular course of the field strength. It has thus been found, surprisingly, that in the case of polycarbonate produced by the phase interface process, the field strength on any disk increases after the start of the injection molding process (provided a new template is inserted) and reaches a plateau or increases further only a little with the passage of time. This was not known hitherto and is an important criterion for the performance of the injection-molded part in the subsequent production step in which e.g. the dyestuff is applied to the substrate. With the substrate materials according to the invention, initially high electrical fields may occur on the injection-molded articles which are produced in a continuous production process. Nevertheless, the value of the electrical field already lies in an acceptable range after a short time and changes further only little per unit time. The overall reject-rate during the continuous injection molding process is therefore significantly lower compared with conventional substrate materials.

As a decisive quality feature for the coating of injection-molded parts, in particular for the coating of transparent optical disks or of transparent diffusing screens, it has thus been found, surprisingly, that substrate materials suitable in the context of the invention are mostly those which do not exceed a particular field strength after a period of a continuous injection molding process as determined in accordance with the invention at a defined distance to the surface of the substrate and at a defined temperature and air moisture.

The present invention therefore provides a substrate material, preferably polycarbonate prepared by the phase interface process, for the production of transparent injection-moulded parts which are to be coated, which results in disks with an integral value of the electrical field, measured at a distance of 100 mm from the substrate surface, of between −30 and 0 kV/m, preferably between −20 and 0 kV/m, within the first 5 minutes of the injection moulding process, and results disks with an integral value of electrical E field of between 0 and 25 kV/m, and particularly preferably of between 0 and +18 kV/m, after 180 to 185 minutes. The present invention furthermore provides a substrate material, preferably polycarbonate, prepared by the phase interface process, which does not exceed an integral average value of the field of +18 kV/m, measured at a distance of 100 mm from the corresponding injection-moulded articles (measured at a distance of 100 mm from the substrate surface), after 3 hours of a continuous injection moulding process.

The electrical field caused by surface charges on the substrate substantially depends on the geometry and the dimensions of the injection-molded article and the nature of the injection molding process. It is therefore important to carry out the measurement on the injection-molded article, which is to be coated, itself, such as e.g. a disk for an optical data carrier.

All the values described above and measured apply to moldings which have been produced via the known injection molding process, at a certain atmospheric humidity and room temperature without the use of ionizers.

In order to ensure a good coatability of the disks in the production process, so-called ionizers which conduct a stream of ionized air over the disks are often employed. The abovementioned measurement values for substrate materials according to the invention have been achieved without the use of ionizers. This is a further advantage of the invention, since the use of ionizers makes the production process more expensive. Nevertheless, ionizers may be employed.

The present invention also provides the moldings produced from the substrate materials according to the invention, such as e.g. disks for writable optical data storage media or materials from the automotive glazings sectors, such as e.g. diffusing screens.

Materials which are suitable for the production of the coatable transparent injection-molded parts, preferably optical data storage media, are:

thermoplastics, such as polycarbonate based on bisphenol A (BPA-PC), polycarbonate based on trimethyl-cyclohexyl-bisphenol polycarbonate (TMC-PC), fluorenyl polycarbonate, polymethyl methacrylate, cyclic polyolefin copolymer, hydrogenated polystyrenes (HPS) as well as amorphous polyolefins and polyesters.

Polycarbonate is particularly suitable for the production of the coatable transparent injection-molded parts.

The substrate materials according to the invention and injection-molded articles obtainable therefrom, in particular disks, may be produced by conventional procedures known to the art-skilled.

The course of the field strength on an injection-molded article, as has been described above, may be influenced by several factors. For example, the purity of the educts and auxiliary substances is of importance. Furthermore, process parameters such as the molar ratio of the bisphenol employed and phosgene, temperatures during the reaction, reaction and dwell times, may be decisive. For the person skilled in the art, the object is to control the process such that the limits according to the invention in terms of the field strength (measured on appropriate injection-molded parts) are not exceeded. The measurement described relating to field strength is suitable for controlling the process for the person skilled in the art.

A suitable choice of process parameters in order to obtain the desired substrate material may appear as follows:

While the excess of phosgene used in the preparation of polycarbonate in the continuous phase interface process , based on the total of bisphenols employed, is between 3 and 100 mol %, preferably between 5 and 50 mol %, in conventional continuous polycarbonate synthesis, the substrate material according to the invention is prepared at phosgene excesses of from 5 to 20 mol %, preferably 8 to 17 mol %. In this context, the pH of the aqueous phase during and after the metering of the phosgene is kept in the alkaline range, preferably between 8.5 and 12, by subsequent metering of sodium hydroxide solution once or several times or appropriate subsequent metering of bisphenolate solution, while it is adjusted to 10 to 14 after addition of the catalyst. The temperature during the phosgenation is 0° C. to 40° C., preferably 5° C. to 36° C.

The polycarbonates according to the invention may be prepared by the phase interface process. This process for polycarbonate synthesis is described in many instances in the literature; reference may be made by way of example to H. Schnell, Chemistry and Physics of Polycarbonates, Polymer Reviews, vol. 9, Interscience Publishers, New York 1964 p. 33 et seq., to Polymer Reviews, vol. 10, “Condensation Polymers by Interfacial and Solution Methods”, Paul W. Morgan, Interscience Publishers, New York 1965, chap. VIII, p. 325, to Dres. U, Grigo, K. Kircher and P. R. Müller “Polycarbonate” in Becker/Braun, Kunststoff-Handbuch, vol. 3/1, Polycarbonate, Polyacetale, Polyester, Celluloseester, Carl Hanser Verlag Munich, Vienna 1992, p. 118-145 and to EP-A 0 517 044.

According to this process, the phosgenation of a disodium salt of a bisphenol (or of a mixture of various bisphenols) which has been initially introduced into an aqueous-alkaline solution (or suspension) is carried out in the presence of an inert organic solvent or solvent mixture which forms a second phase. The oligocarbonates formed, which are chiefly present in the organic phase, are subjected to further condensation with the aid of suitable catalysts to give high molecular weight polycarbonates dissolved in the organic phase. Finally, the organic phase is separated off and the polycarbonate is isolated therefrom by various working up steps.

Dihydroxyaryl compounds which are suitable for the preparation of polycarbonates are those of the formula (2)
HO-Z-OH (2)
in which
Z is an aromatic radical having 6 to 30 C atoms, which may contain one or more aromatic nuclei, may be substituted and may contain aliphatic or cycloaliphatic radicals or alkylaryls or heteroatoms as bridge members.

Preferably, Z in formula (2) represents a radical of the formula (3) 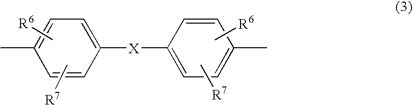
in which
R⁶ and R⁷ independently of one another represent H, C₁-C₁₈-alkyl, C₁-C₁₈-alkoxy, halogen, such as Cl or Br, or in each case optionally substituted aryl or aralkyl, preferably H or C₁-C₁₂-alkyl, particularly preferably H or C₁-C₈-alkyl, and very particularly preferably H or methyl, and x represents a single bond, —SO₂—, —CO—, —O—, —S—, C₁- to C₆-alkylene, C₂- to C₅-alkylidene or C₅- to C₆-cycloalkylidene, which may be substituted by C₁- to C₆-alkyl, preferably methyl or ethyl, and furthermore C₆- to C₁₂-arylene, which may optionally be fused with further aromatic rings containing heteroatoms.

Preferably, X represents a single bond, C₁ to C₅-alkylene, C₂ to C₅-alkylidene, C₅ to C₆-cycloalkylidene, —O—, —SO—, —CO—, —S—, —SO₂—,

or a radical of the formula (3a) or (3b) 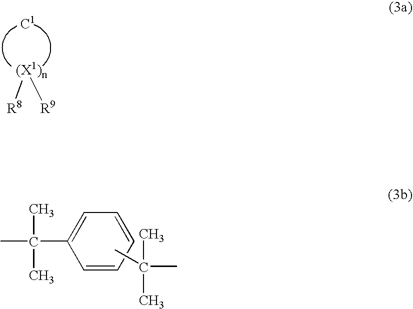
wherein
R⁸ and R⁹ may be chosen individually for each X¹ and independently of one another denote hydrogen or C₁ to C₆-alkyl, preferably hydrogen, methyl or ethyl, and
X¹ denotes carbon and
n denotes an integer from 4 to 7, preferably 4 or 5, with the proviso that on at least one atom X¹, R⁸ and R⁹ are simultaneously alkyl.

Examples of dihydroxyaryl compounds are: dihydroxybenzenes, dihydroxydiphenyls, bis-(hydroxyphenyl)-alkanes, bis-(hydroxyphenyl)-cycloalkanes, bis-(hydroxyphenyl)-aryls, bis-(hydroxyphenyl)ethers, bis-(hydroxyphenyl)ketones, bis-(hydroxyphenyl)sulfides, bis-(hydroxyphenyl)sulfones, bis-(hydroxyphenyl)sulfoxides, 1,1′-bis-(hydroxyphenyl)-diisopropylbenzenes and nucleus-alkylated and nucleus-halogenated compounds thereof.

Aromatic dihydroxy compounds which are suitable for the preparation of the polycarbonates to be used according to the invention are, for example, hydroquinone, resorcinol, dihydroxydiphenyl, bis-(hydroxyphenyl)-alkanes, bis-(hydroxyphenyl)cycloalkanes, bis-(hydroxyphenyl) sulfides, bis-(hydroxyphenyl) ethers, bis-(hydroxyphenyl)ketones, bis-(hydroxyphenyl)sulfones, bis-(hydroxyphenyl)sulfoxides, α,α′-bis-(hydroxyphenyl)-diisopropylbenzenes and alkylated, nucleus-alkylated and nucleus-halogenated compounds thereof.

Preferred diphenols are 4,-dihydroxydiphenyl, 2,2-bis-(4-hydroxyphenyl)-1-phenyl-propane, 1,1-bis-(4-hydroxyphenyl)-phenyl-ethane, 2,2-bis-(4-hydroxyphenyl)propane, 2,4-bis-(4-hydroxyphenyl)-2-methylbutane, 1,3-bis-[2-(4-hydroxyphenyl)-2-propyl]benzene (bisphenol M), 2,2-bis-(3-methyl-4-hydroxyphenyl)-propane, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl)sulfone, 2,4-bis-(3,5-dimethyl-4-hydroxyphenyl)-2-methylbutane, 1,3-bis-[2-(3,5-dimethyl-4-hydroxyphenyl)-2-propyl]-benzene and 1,1-bis-(4-hydroxyphenyl)-3,3,5-trimethylcyclohexane (bisphenol TMC).

Particularly preferred diphenols are 4,4′-dihydroxydiphenyl, 1,1-bis-(4-hydroxyphenyl)-phenylethane, 2,2-bis-(4-hydroxyphenyl)-propane, 2,2-bis-(3,5-dimethyl-4-hydroxyphenyl)-propane, 1,1-bis-(4-hydroxyphenyl)-cyclohexane and 1,1-bis-(4-hydroxyphenyl)-3,3,5-trimethylcyclohexane (bisphenol TMC).

These and further suitable diphenols are described e.g. in U.S. Pat. No. 2,999,835, 3,148,172, 2,991,273, 3,271,367, 4,982,014 and 2,999,846, in the German Offenlegungsschriften 1 570 703, 2 063 050, 2 036 052, 2 211 956 and 3 832 396, the French Patent Specification 1 561 518, in the monograph “H. Schnell, Chemistry and Physics of Polycarbonates, Interscience Publishers, New York 1964, p. 28 et seq.; p. 102 et seq.” and in “D. G. Legrand, J. T. Bendler, Handbook of Polycarbonate Science and Technology, Marcel Dekker New York 2000, p. 72 et seq.”.

In the case of the homopolycarbonates, only one aromatic dihydroxy compound is employed, and in the case of copolycarbonates two or more such compounds are employed. The diphenols used, like all other chemicals and auxiliary substances added to the synthesis, may be contaminated with the impurities originating from their own synthesis, handling and storage. However, it is desirable to use raw materials which are as pure as possible.

The monofunctional chain terminators required for regulating the molecular weight, such as phenol or alkylphenols, in particular phenol, p-tert-butylphenol, iso-octylphenol, cumylphenol, chlorocarbonic acid esters thereof or acid chlorides of monocarboxylic acids or mixtures of these chain terminators, are either fed with the bisphenolate or the bisphenolates to the reaction or added to the synthesis at any desired point in time, as long as phosgene or chlorocarbonic acid end groups are still present in the reaction mixture or, in the case of acid chlorides and chlorocarbonic acid esters as chain terminators, as long as sufficient phenolic end groups of the polymer forming are available. Preferably, however, the chain terminator or terminators are added after the phosgenation, at a place or at a point in time when phosgene is no longer present but the catalyst has not yet been metered in, or they are metered in before the catalyst, together with the catalyst or in parallel thereto.

In the same manner, any branching agents or branching agent mixtures to be used may be added to the synthesis, but conventionally before the chain terminators. Trisphenols, quaternary phenols or acid chlorides or tri- or tetracarboxylic acids, or also mixtures of the polyphenols or of the acid chlorides, are conventionally used.

Some of the compounds which have three or more phenolic hydroxyl groups and may be used are, for example,
phloroglucinol,
4,6-dimethyl-2,4,6-tri-(4-hydroxyphenyl)-hept-2-ene,
4,6-dimethyl-2,4,6-tri-(4-hydroxyphenyl)-heptane,
1,3,5-tri-(4-hydroxyphenyl)-benzene,
1,1,1-tri-(4-hydroxyphenyl)-ethane,
tri-(4-hydroxyphenyl)-phenylmethane,
2,2-bis-(4,4-bis-(4-hydroxyphenyl)-cyclohexyl]-propane,
2,4-bis-(4-hydroxyphenylisopropyl)-phenol,
tetra-(4-hydroxyphenyl)-methane.

Some of the other trifunctional compounds are 2,4-dihydroxybenzoic acid, trimesic acid, cyanuric chloride and 3,3-bis-(3-methyl-4-hydroxyphenyl)-2-oxo-2,3-dihydroindole.

Preferred branching agents are 3,3-bis-(3-methyl-1,4-hydroxyphenyl)-2-oxo-2,3-dihydroindole and 1,1,1-tri-(4-hydroxyphenyl)-ethane.

The catalysts used in the phase interface synthesis are tertiary amines, in particular triethylamine, tributylamine, trioctylamine, N-ethylpiperidine, N-methylpiperidine and N-i/n-propylpiperidine; quaternary ammonium salts, such as tetrabutyl-ammonium/tributylbenzylammonium/tetraethylammonium hydroxide/chloride/bromide/hydrogen sulfate/tetrafluoroborate; and the phosphonium compounds corresponding to the ammonium compounds. These compounds are described as typical phase interface catalysts in the literature, are commercially obtainable and are familiar to the person skilled in the art. The catalysts may be added to the synthesis individually, in a mixture or also side by side and successively, optionally also before the phosgenation, but meterings after the introduction of phosgene are preferred, unless an onium compound or mixtures of onium compounds are used as catalysts, in which case an addition before the metering of phosgene is preferred. The catalyst or catalysts may be metered in bulk, in an inert solvent, preferably that of the polycarbonate synthesis, or also as an aqueous solution, and in the case of the tertiary amines then as ammonium salts thereof with acids, preferably mineral acids, in particular hydrochloric acid. If several catalysts are used or part amounts of the total amount of catalysts are metered, various methods of metering may of course also be carried out at various places or at various times. The total amount of catalysts used is between 0.001 to 10 mol %, based on the moles of bisphenols employed, preferably 0.01 to 8 mol %, particularly preferably 0.05 to 5 mol %.

The conventional additives may also be added in the conventional amounts to the material according to the invention. The addition of additives serves to prolong the useful life or the color (stabilizers), simplify processing (e.g. mold release agents, flow auxiliaries, antistatics) or adapt the polymer properties to particular stresses (impact modifiers, such as rubbers; flameproofing agents, coloring agents, glass fibers).

These additives may be added to the polymer melt individually or in any desired mixtures or several different mixtures, and in particular directly during isolation of the polymer or after melting of granules, in a so-called compounding step. In this context, the additives or mixtures thereof may be added to the polymer melt as a solid, i.e. as a powder, or as a melt. Another method of metering is the use of masterbatches or mixtures of masterbatches of the additives or additive mixtures.

Suitable additives are described, for example, in “Additives for Plastics Handbook, John Murphy, Elsevier, Oxford 1999” and in “Plastics Additives Handbook, Hans Zweifel, Hanser, Munich 2001”.

Preferred heat stabilizers are, for example, organic phosphites, phosphonates and phosphanes, usually those in which the organic radicals consist entirely or partly of optionally substituted aromatic radicals. UV stabilizers which are employed are e.g. substituted benzotriazoles. These and other stabilizers may be used individually or in combination and added in the forms mentioned to the polymer.

Processing auxiliaries, such as mold release agents, usually derivatives of long-chain fatty acids, may moreover be added. Pentaerythritol tetrastearate and glycerol monostearate e.g. are preferred. They are employed by themselves or in a mixture, preferably in an amount of from 0.02 to 1 wt. %, based on the weight of the composition.

Suitable flame-retardant additives are phosphate esters, i.e. triphenyl phosphate, resorcinol-diphosphoric acid esters, bromine-containing compounds, such as brominated phosphoric acid esters and brominated oligocarbonates and polycarbonates, and, preferably, salts of fluorinated organic sulfonic acids.

Suitable impact modifiers are, for example, graft polymers comprising one or more graft bases chosen from at least one polybutadiene rubber, acrylate rubber (preferably ethyl or butyl acrylate rubber) and ethylene/propylene rubbers, and graft monomers chosen from at least one monomer from the group consisting of styrene, acrylonitrile and alkyl methacrylate (preferably methyl methacrylate), or interpenetrating siloxane and acrylate networks with grafted-on methyl methacrylate or styrene/acrylonitrile.

Coloring agents, such as organic dyestuffs or pigments or inorganic pigments, IR absorbers, individually, in a mixture or also in combination with stabilizers, glass fibers, glass (hollow) beads and inorganic fillers, may furthermore be added.

The present application furthermore provides the extrudates and moldings obtainable from the substrate materials according to the invention, in particular those for use in the transparent sector, very particularly in the optical uses sector, such as e.g. sheets, multi-wall sheets, glazing, diffusing screens and lamp covers, or optical data storage media, such as audio-CD, CD-R(W), DVD, DVD-R(W) and minidisks in their various only readable or once writable and optionally also repeatedly writable embodiments.

The present invention furthermore provides the use of the materials , preferably polycarbonates, according to the invention for the production of extrudates and moldings.

The substrate material according to the invention, preferably polycarbonate, may be processed by injection molding by known processes. A disk produced in this way may be e.g. an audio-CD or a super-audio-CD, CD-R, CD-RW, DVD, DVD-R, DVD+R, DVD-RW, DVD+RW or BR.

The CD-R (write once, read many) thus comprises a substrate having concentrically formed guide depressions (pregrooves) which are transferred from a nickel template in the injection molding process. Via a template which has depressions on a sub-micrometre scale, these are transferred accurately to the surface of the substrate in the injection molding process. The CD-R comprises the abovementioned substrate, a dyestuff recording layer, a reflection layer and protective layer, which are applied or laminated on to the substrate in this sequence. Another example for a once-writable optical disk which may be read again several times is the DVD-R, which comprises the substrate, a dyestuff recording layer, a reflection layer and optionally a protective layer which are likewise applied in this sequence to the substrate described above and are glued with a second disk (“dummy disk”).

The dyestuff layer is applied via a “spin coating” process. In this production step, the particular dyestuff, dissolved in an organic solvent, is applied to the information layer of the substrate and introduced uniformly in the radial direction into the depressions of the substrate by rotation of the disk. After this step, the dyestuff layer is dried.

The dyestuff to be used for the use described above has an absorption range which lies in the range of the laser used (300-850 nm). Examples of dyestuff types are e.g. cyanines, phthalocyanines, squarylium dyestuffs, polymethines, pyrilium and thiopyrilium dyestuffs, indoanilines, naphthoquinones, anthraquinones and various metal-chelate complexes, such as e.g. azo coordination compounds, cyanines or phthalocyanines. These dyestuffs have a good signal sensitivity and good solubility in organic solvents and light-fastness and are therefore preferred dyestuffs for the uses described above.

Examples of solvents are esters, such as butyl acetate, ketones, such as methyl ethyl ketone, cyclohexanone, methyl isobutyl ketone and 2,4-dimethyl-4-heptanone (DMH), chlorinated hydrocarbons, such as 1,2-dichloroethane and chloroform, amides, such as dimethylformamide, hydrocarbons, such as cyclohexane, methylcyclohexane or ethylcyclohexane, ethers, such as THF and dioxane, alcohols, such as ethanol, propanol, isopropanol, n-butanol and diacetone alcohol, fluorinated solvents, such as 2,2,3,3-tetrafluoropropanol, and glycol ethers, such as ethylene glycol monomethyl ether and propylene glycol monomethyl ether. These may be employed individually or as mixtures. Preferred solvents are fluorinated solvents, such as 2,2,3,3-tetrafluoropropanol, octafluoropentanol and dibutyl ether.

A reflection layer, e.g. comprising gold or silver, may be applied to the dyestuff layer via a sputtering method. A protective layer may optionally be applied to the reflection layer.

The disk substrate according to the invention and the optical disk according to the invention show clearly improved antistatic properties and improved coatability.

The injection-molded part is obtained by conventional injection molding processes. In the examples part of the present Application, the injection-molded part is produced as follows:

An optical disk is chosen for production of the moldings according to the invention; the following injection molding parameters and conditions are established:
Machine: Netstal Discjet
Template: Audio stamper
Cycle time: 4.4 seconds
Melt temperature: 310-330° C.
Substrate dimensions: Audio-CD
Mold temperature on the template side: 60° C.

Before the start of the injection molding process, a new audio stamper was inserted into the machine. Before the new stamper was inserted, the entire injection molding unit was cleaned from the preceding material to assure correct measurements.

A field meter from Eltec (EMF 581230) was used to measure the electrical field strength. Immediately after the end of the injection molding process, the molding, in the examples of the present application, a disk, was removed via a robot arm and stacked. During this operation the disk must not come into contact with metal, since otherwise the measurement is impaired. Furthermore, any ionizers present must be switched off before measurement in order not to interfere with the results.

The measuring device is positioned above the disk at a distance of 100 mm from the horizontally positioned disk surface. The center of the field meter is positioned in such a way that its projection on the actual measured disc extends 39 mm from the center of the disc. The disk was not moved during this operation. The field was thus measured within a period of 3-10 seconds after conclusion of the injection molding process.

The measuring instrument was connected to an x/y plotter, on which the values were printed out. Each disk measured was thus assigned a particular integral value of the electrical field. To limit the amount of data, 100 measurements were performed after the start of the process, i.e. the corresponding electrical field of the first 100 disks was recorded. 100 further measurement were carried out after every 60 minutes. After the 4th measurement series, i.e. after approx. 3 hours, the measurement was stopped.

When carrying out the measurement, it is to be ensured that the atmospheric humidity during the measurement is 30 to 60%, preferably 35 to 50%, and the room temperature is 25 to 28° C.

The dyestuff application may be carried out via “spin coating” as described above. A phthalocyanine is preferably used as the dyestuff and dibutyl ether is preferably used as the solvent. The application of dyestuff starts at a distance of 2 mm from the innermost track. The speed of rotation during application of the dyestuff is 200 rpm. To distribute the solution over the entire disk, the speed may be increased to 5,000 rpm.

The coatability with dyestuff was measured by light microscopy examination of the inner region of the disk coated with dyestuff. If a deviation from the color edge of 0.5 mm or higher is found at a place of the outer dyestuff edge, the wetting properties of this disk are inadequate.

A further indirect possibility of measuring the coatability is that of checking the disk coated e.g. with dyestuff with a camera or laser system. In this case, the information recorded is evaluated via image processing software and wetting errors which occur are recognized (“in-line” detection). Defective disks are automatically discarded.

### EXAMPLES

### Example 1

The polycarbonate was prepared by the known phase interface process. A continuous process was used.

The bisphenolate solution (bisphenol A; alkali content 2.12 mol NaOH/mol BPA) was fed into the reactor at 750 kg/h (14.93 wt. %), the solvent (methylene chloride/chlorobenzene 1:1) at 646 kg/h and the phosgene at 56.4 kg/h and the components were reacted. The temperature in the reactor was 35° C. Sodium hydroxide solution (32 wt. %) was also metered in at 9.97 kg/h. In the course of the condensation reaction, a second amount of sodium hydroxide solution (32 wt. %) was metered in at 29.27 kg/h, as well as a solution of chain terminators (11.7 wt. % tert-butylphenol in methylene chloride/chlorobenzene 1:1) at 34.18 kg/h. Thereafter, N-ethylpiperidine, dissolved in methylene chloride/chlorobenzene (1:1; 2.95 wt. % N-ethylpiperidine) was fed in at 33.0 kg/h as a catalyst. The phases were separated and the organic phase washed once with dilute hydrochloric acid and five times with water. The polycarbonate solution was then concentrated, in an evaporating tank and the polymer melt spun off via a devolatilization extruder and granulated.

The granules obtained were dried for 6 hours and processed to disks on a Netstal Discjet injection molding machine (see above) over a cycle time of 4.4 seconds under the abovementioned parameters. An audio stamper was used as the template. The electrical field of each of the first 100 disks was measured with a field meter as described above. After one hour, a further 100 disks were measured in succession; the injection molding process was not interrupted here.

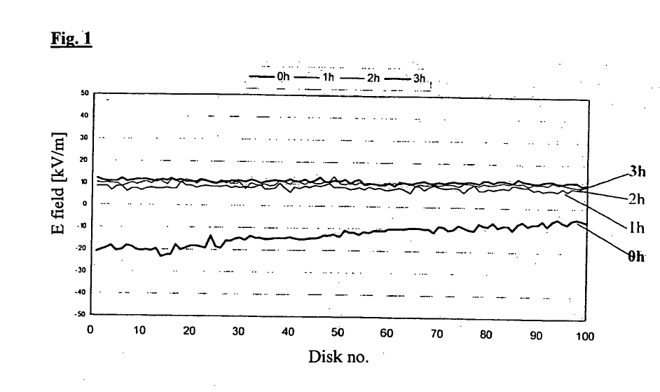

Furthermore, likewise in each case 100 disks were measured in succession after the 2nd and 3rd hour. The result of the field measurement is shown in FIG. 1.

FIG. 1:
0 h: Measurement of the first 100 disks after the start of the injection molding process
1 h: Measurement of a further 100 disks after 60 minutes of a continuous injection molding process
2 h: Measurement of a further 100 disks after 120 minutes of a continuous injection molding process
3 h: Measurement of a further 100 disks after 180 minutes of a continuous injection molding process

### Example 2

### Comparison Example

The polycarbonate was prepared as described in Example 1. However, the bisphenolate solution (bisphenol A) was fed into the reactor at 750 kg/h (14.93 wt. %), the solvent (methylene chloride/chlorobenzene 1:1) at 646 kg/h and the phosgene at 58.25 kg/h. Sodium hydroxide solution (32 wt. %) was likewise metered in at 12.34 kg/h. The second amount of sodium hydroxide solution was metered at 36.20 kg/h; the amount of chain terminators was introduced at 34.18 kg/h at the concentrations stated in Example 1. The rate of introduction of catalyst was 33 kg/h. Working up was carried out as described in Example 1.

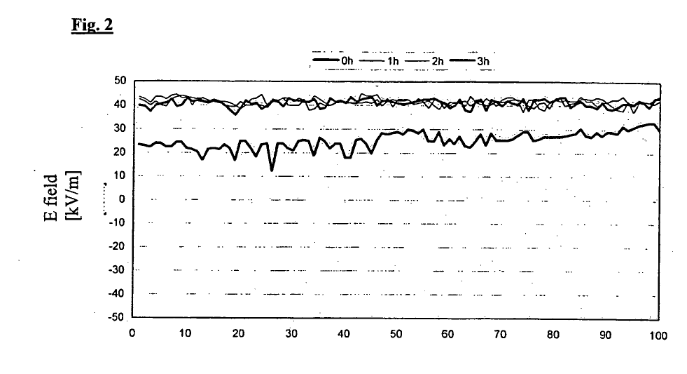

The granules obtained were dried for 6 hours and then processed to disks on a Netstal Discjet injection molding machine (see above) over a cycle time of 4.4 seconds under the abovementioned parameters. An audio stamper was used as the template. The electrical field of each of the first 100 disks was measured with a field meter as described above. After one hour, a further 100 disks were measured in succession; the injection molding process was not interrupted. Furthermore, likewise in each case 100 disks were measured in succession after the 2nd and 3rd hour. The result of the field measurement is shown in FIG. 2.

As is shown in FIG. 2, the field strengths on the injection-molded parts measured clearly lie outside the range according to the invention.
0 h: Measurement of the first 100 disks after the start of the injection molding process
1 h: Measurement of a further 100 disks after 60 minutes of a continuous injection molding process
2 h: Measurement of a further 100 disks after 120 minutes of a continuous injection molding process

3 h: Measurement of a further 100 disks after 180 minutes of a continuous injection molding process

TABLE 1

| | E-Field | E-Field | |
|---|---|---|---|
| Example | start value ¹ | value after 3 h ² | Defects at |
| No.: | [kV/m] | [kV/m] | inner region ³ |
| 1 | −13.0 | 11.5 | no |
| 2 | 25.5 | 41.0 | observed |

¹ Average integral value of electrical field of the first 100 measured disks
² Average integral value of electrical field of 100 disks after 180 minutes of continuous injection molding process
³ Defects at the inner region of the disk (after coating with dye) observed by visual examination with a light microscope

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A polymeric material characterized in that the integral value of the electric field of a flat substrate molded therefrom by continuous injection molding is −30 to 0 kV/m determined within five minutes of molding at a distance of 100 mm therefrom.

2. The material of claim 1 wherein the integral value of the electric field of said substrate is 0 to +25 kV/m determined at a distance of 100 mm from its surface within 180-185 minutes of molding.

3. The material of claim 1 wherein the integral average value of the electrical field of said substrate does not exceed +18 kV/m determined at a distance of 100 mm from its surface 3 hours after its molding.

4. A polymeric material according to claim 1 wherein the integral value of the electric field of a flat substrate molded therefrom by continuous injection molding is −30 to 0 kV/m determined within five minutes of molding at a distance of 100 mm therefrom and the integral value of the electric field of said substrate is 0 to +25 kV/m determined at a distance of 100 mm from its surface within 180-185 minutes of molding.

5. A polymeric material according to claim 1 wherein the integral value of the electric field of a flat substrate molded therefrom by continuous injection molding is −30 to 0 kV/m determined within five minutes of molding at a distance of 100 mm therefrom and the integral value of the electric field of said substrate is 0 to +25 kV/m determined at a distance of 100 mm from its surface within 180-185 minutes of molding and the integral average value of the electrical field of said substrate does not exceed +18 kV/m determined at a distance of 100 mm from its surface 3 hours after its molding.

6. A polycarbonate characterized in that the integral value of the electric field of a flat substrate molded therefrom by continuous injection molding is −30 to 0 kV/m determined within five minutes of molding at a distance of 100 mm therefrom.

7. The polycarbonate of claim 5 wherein the integral value electric field of said substrate is 0 to +25 kV/m determined at a distance of 100 mm from its surface within 180-185 minutes of molding.

8. The polycarbonate of claim 6 wherein the integral average value of the electrical field of said substrate does not exceed +18 kV/m determined at a distance of 100 mm from its surface 3 hours after its molding.

9. Moldings and extrudates obtainable from the polymeric material according to claim 1.

10. Optical data storage medium and diffusing screen obtainable from the polymeric material according to claim 1.
